(19) United States
(12) Patent Application Publication
(10) Pub. No.: US 2006/0022633 A1
(43) Pub. Date: Feb. 2, 2006

(54) High rate power source recharging

(76) Inventor: Don J. Nguyen, Portland, OR (US)

Correspondence Address: INTEL CORPORATION, P.O. BOX 5326, SANTA CLARA, CA, 95056-5326, US

(21) Appl. No.: 10/900,439

(22) Filed: Jul. 27, 2004

(51) Int. Cl. H02J 7/00

(52) U.S. Cl. 320/106

(57) ABSTRACT

Embodiments of the present invention can determine the type of power source that is installed in a device, and then apply the appropriate recharging rate to the power source. In one embodiment of the present invention, it may be possible to safely interchange high-rate and slow-rate power sources in the same device. In another embodiment, a device may include multiple power sources, each having any of a variety of recharge rates, and the same recharging circuitry can be used to safely recharge each power source at the appropriate rate.

### FIELD OF THE INVENTION

The present invention relates to the field of power sources. More specifically, the present invention relates to recharging power sources at a high rate.

### BACKGROUND

A typical battery pack for a notebook computer may take three to four hours to fully recharge. These battery packs are usually recharged slowly in order to extend the cycle life of the batteries. That is, each cycle of depleting and recharging a chemical battery breaks it down a little more, reducing the maximum charge that the battery can hold. The cycle life of a battery is the number of times that it can be depleted and recharged, and still hold enough power to be useful. Usually, the faster a chemical battery is recharged, the faster it breaks down, and the shorter its cycle life is.

New battery technologies are being developed for notebook computers that can be recharged much more quickly. These new batteries include various chemical technologies as well as super capacitors. Recharging one of these newer, faster batteries usually involves applying a much larger current than the current used to charge the older, slower batteries. If one of these larger currents were inadvertently applied to an older, slower battery, the battery could be damaged, or even explode violently and burn furiously.

### BRIEF DESCRIPTION OF DRAWINGS

Examples of the present invention are illustrated in the accompanying drawings. The accompanying drawings, however, do not limit the scope of the present invention. Similar references in the drawings indicate similar elements.

FIG. 1 illustrates one embodiment of a power system.

FIG. 2 illustrates another embodiment of a power system.

FIG. 3 illustrates one embodiment of identification circuitry and power pack.

FIG. 4 illustrates one embodiment of a control unit.

FIG. 5 illustrates one embodiment of a charger.

FIG. 6 illustrates one embodiment of voltage and current curves for low rate charging.

FIG. 7 illustrates one embodiment of a voltage curve for high rate charging.

FIG. 8 illustrates one embodiment of a voltage curve for three-phase high rate charging.

FIG. 9 demonstrates one embodiment of the present invention.

FIG. 10 demonstrates one embodiment of recharging mode selection.

FIG. 11 demonstrates another embodiment of recharging mode selection.

FIG. 12 illustrates one embodiment of a hardware system that can perform various functions of the present invention.

FIG. 13 illustrates one embodiment of a machine readable medium to store instructions that can implement various functions of the present invention.

### DETAILED DESCRIPTION OF THE INVENTION

In the following detailed description, numerous specific details are set forth in order to provide a thorough understanding of the present invention. However, those skilled in the art will understand that the present invention may be practiced without these specific details, that the present invention is not limited to the depicted embodiments, and that the present invention may be practiced in a variety of alternative embodiments. In other instances, well known methods, procedures, components, and circuits have not been described in detail.

Parts of the description will be presented using terminology commonly employed by those skilled in the art to convey the substance of their work to others skilled in the art. Also, parts of the description will be presented in terms of operations performed through the execution of programming instructions. As well understood by those skilled in the art, these operations often take the form of electrical, magnetic, or optical signals capable of being stored, transferred, combined, and otherwise manipulated through, for instance, electrical components.

Various operations will be described as multiple discrete steps performed in turn in a manner that is helpful for understanding the present invention. However, the order of description should not be construed as to imply that these operations are necessarily performed in the order they are presented, nor even order dependent. Lastly, repeated usage of the phrase “in one embodiment” does not necessarily refer to the same embodiment, although it may.

Embodiments of the present invention can determine the type of power source that is installed in a device, and then apply the appropriate recharging rate to the power source. Embodiments of the present invention can be used in a wide variety of beneficial ways. For instance, in one embodiment, it may be possible to safely interchange high-rate and slow-rate power sources in the same device. In another embodiment, a device may include multiple power sources, each having any of a variety of recharge rates, and the same recharging circuitry can be used to safely recharge each power source at the appropriate rate.

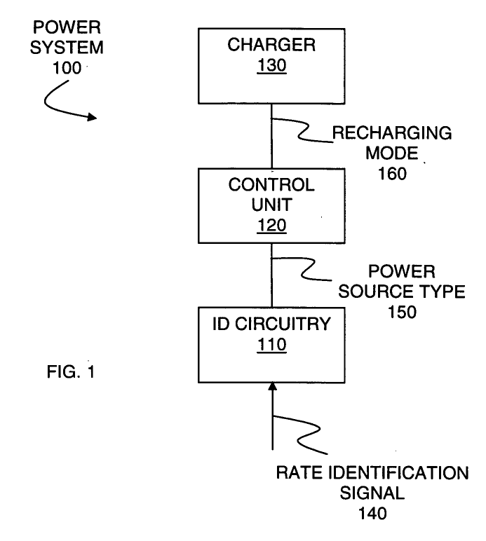

FIG. 1 illustrates one embodiment of the present invention at a high level. Power system 100 includes identification circuitry 110, a control unit 120, and a charger 130. Identification circuitry 110 can receive a rate identification signal 140 from a power pack (not shown). Identification circuitry 110 can use the rate identification signal 140 to determine the power source type 150 of the power pack and provide the power source type 150 to control unit 120. Then, based on the power source type 150, control unit 120 can select a recharging mode 160 for charger 130 to apply to the power pack.

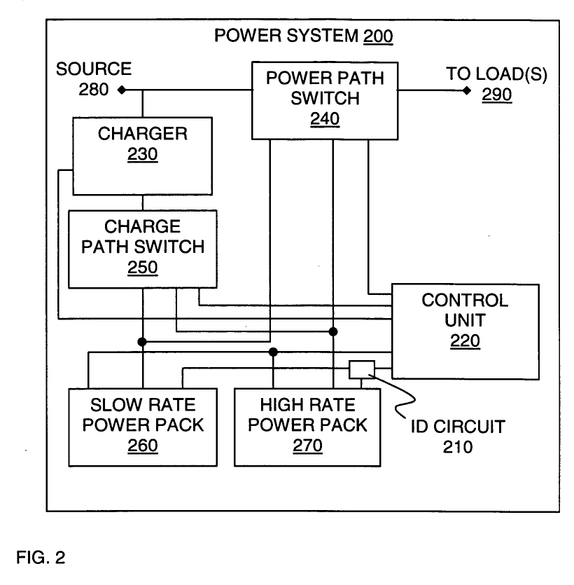

The functions performed by elements 110, 120, and 130 can be implemented in a wide variety of ways and used in a wide variety of devices. For example, FIG. 2 illustrates one embodiment of a power system 200 that could be used in a notebook computer. Power system 200 can receive power at source 280 from, for instance, an AC wall outlet, a fuel cell, a solar collector, etc. Power system 200 can also receive power from two power packs, 260 and 270. One or both of the power packs 260 and 270 could be removable and/or interchangeable.

Control unit 220 can control power path switch 240 to select a power source to supply power at 290 for the notebook computer. For instance, if an external power source is connected to source 280, control unit 220 may set switch 240 to select source 280. If the notebook is not connected to an external power source, control unit 220 may set switch 240 to select one of the power packs 260 or 270. Control unit 220 could also use multiple power sources simultaneously, or switch among power sources over time, depending on a variety of factors, such as the power load being drawn by the notebook computer, the amount of charge available from each power source, etc.

Power system 200 also includes a charger 230. When an external power source is connected to source 280, charger 230 can recharge the power packs 260 and 270. Control unit 220 can control charger 230 and charge path switch 250 to select a power pack to recharge and an appropriate recharging mode for that power pack.

For example, in the illustrated embodiment, power pack 260 is a slow rate power pack and power pack 270 is a high rate power pack. This means that power pack 270 can be recharged faster than power pack 260 by applying a larger current. This larger current could damage power pack 260, reducing its cycle life and possibly even causing a fiery explosion. In order to safely charge both kinds of power packs, power system 200 includes identification circuit 210 that informs control unit 220 as to the type of power packs that are installed.

Power packs 260 and 270 can have a wide variety of recharge rates, from several hours to just a few minutes. There is usually a trade-off between recharge rate on one hand, and charge duration and shelf life on the other hand. For example, a drained super capacitor may be able to recharge to 90% capacity in just 5 minutes. That 90% charge may be able to power a notebook computer for a couple of hours. Left unused however, the charge may substantially dissipate in just a few days.

In contrast, a drained lithium ion battery may only recharge a couple of percentage points in five minutes. In order to store a couple of hours worth of charge, a lithium ion battery may need to recharge for a couple of hours. To fully recharge, it may take 3 or 4 hours. Once fully recharged however, a lithium ion battery may be able to power a notebook computer for 8 hours. And, left unused, a lithium ion battery may take several months to substantially dissipate.

All of these percentages and time frames are merely examples, and they may be different for various super capacitors, lithium ion batteries, and other battery technologies. The point is, power packs with different recharge rates can provide different advantages and disadvantages, and embodiments of the present invention make it possible for a device to safely support multiple types of battery packs to take advantage of each supported type.

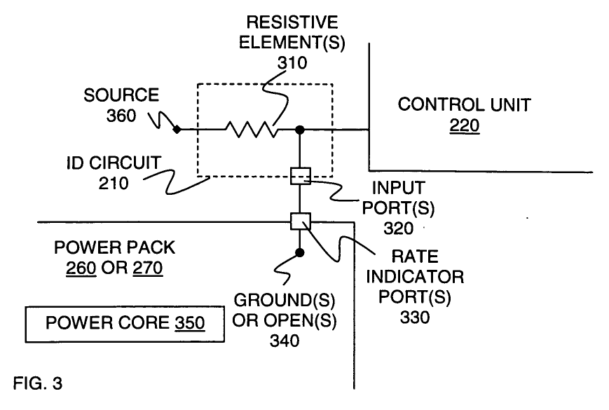

FIGS. 3 through 5 illustrate some examples of circuits that could be used in power system 200 in various embodiments of the present invention. FIG. 3 illustrates one embodiment of an identification circuit 210 that could be used with power pack 260 or 270. In FIG. 3, identification circuit 210 includes resistive element(s) 310 and input port(s) 320. In addition to a power core 350, the power pack includes rate indicator port(s) 330 coupled to one or more rate indicators, ground(s) or open(s) 340.

If control unit 220 supports only two different kinds of recharge types, then a single bit can be used to represent the two different types. That is, a logical one can represent one type and a logical zero can represent the other. In which case, identification circuit 210 would only need one resistive element 310 and one input port 320, and the battery pack would only need one rate indicator 340 and rate indicator port 330. For instance, with source voltage 360 at one end of resistive element 310 and an open circuit 340 at the other end, identification circuit 210 could provide a logical one to control unit 220. Or, with the source voltage 360 at one end of resistive element 310 and a ground 340 at the other end, identification circuit 210 could provide a logical zero to control unit 220.

With this version of identification circuit 210, it may be beneficial to use the open circuit and the resulting logical one to represent a slower rate power pack. This could make the safer, slower recharging mode the default mode. For instance, if the rate indicator port 330 failed to make contact with the input port 320, or if an older power pack that did not include a rate indicator port 330 were installed in the device, the identification circuit 210 would likely experience an open circuit and provide a logical one to controller 220. In which case, the power pack receive the lower recharging current, reducing the chances of inadvertently applying the higher recharging rate to a slower rate power pack.

If control unit 220 supports more than two different kinds of recharge types, multiple bits could be used to represent all the potential types. For example, two bits could be used to represent up to four different recharge types. In which case, identification circuit 210 could include an array of resistive elements 310 and input ports 320, and the battery pack could include a corresponding array of rate indicators 340 and rate indicator ports 330.

In alternate embodiments, any number of digital circuits or analog modulations could be used to identify the recharge type of a battery pack. For instance, one signal line could be used to represent more than two recharge types based on an average analog voltage level measured on the signal line. The circuit elements could also be arranged or distributed in a variety of different ways. For instance, the identification circuit could simply be an input port in the power system to connect the battery pack directly to the controller, and the bulk of the identification function could be contained within the power pack itself. Similarly, rather than an open or ground, any of a variety of registers or memory devices could be included in a power pack to indicate the recharging type.

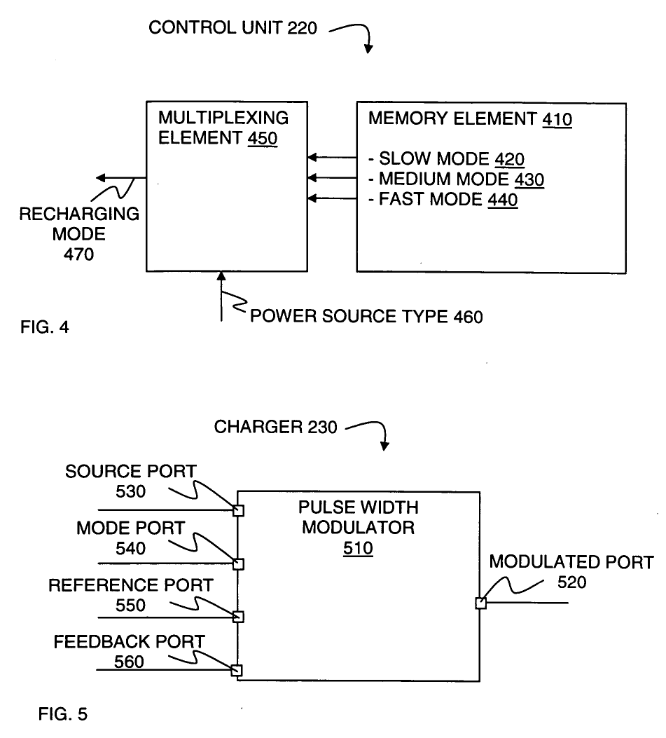

FIG. 4 illustrates one embodiment of a circuit that can be used in control unit 220 to select the recharging mode to be used by charger 230. The circuit includes a multiplexing element 450 and a memory element 410. The memory element 410 can store a number of potential recharging mode control signals. In the illustrated embodiment, the control signals include slow 420, medium 430, and fast 440 modes. The multiplexing element 450 can select one of the potential modes based on the power source type 460, and provide the selected recharge mode 470 to the charger (not shown). The format of the control signals depends on the type of input that the charger can receive from the control unit.

Any number of circuit and/or register configurations can be used to implement the functions of multiplexing element 450 and memory element 410. With three potential recharging modes in the illustrated embodiment, at least two signal lines may be needed to digitally represent the power source type 460 and/or the recharging mode 470. Alternative embodiments can select and represent the recharging mode in any number of ways. For instance, rather than storing or generating digital signals, the potential recharging modes could be represented using any of a variety of analog signal modulations.

FIG. 5 illustrates one embodiment of a pulse width modulator 510 that could be used for charger 230. As discussed more fully below, modulator 510 can modulate a source voltage received at source port 530 to recharge a power source coupled to modulated port 520. At feedback port 560, modulator 510 can monitor the power source as it is being recharged. Using input signals from mode port 540 and reference port 550, modulator 510 can apply the appropriate recharging mode and adjust the recharging rate accordingly. Any of a variety of pulse width modulation techniques, devices, or circuits can be used for modulator 510.

A pulse width modulator can modulate (turn on and off) a signal at a particular rate. By adjusting the duty ratio (the percentage of each periodic cycle of the modulation that is on versus off), the modulator can adjust the average power provided by the modulated signal. For example, a modulator can provide the maximum average power when 100% of each cycle is on, zero average power when 0% of each cycle is on, and x percent of the maximum average power when x percent of each cycle is on.

The duty ratio can be set by comparing a feedback signal to a reference signal. The feedback signal can be taken from any of a variety of places in the output path of the modulator. The feedback signal is supposed to be indicative of the signal level received at a load being powered by the modulator. If the feedback signal falls below the reference signal, the modulator can increase the duty ratio. If the feedback signal rises above the reference signal, the modulator can decrease the duty ratio.

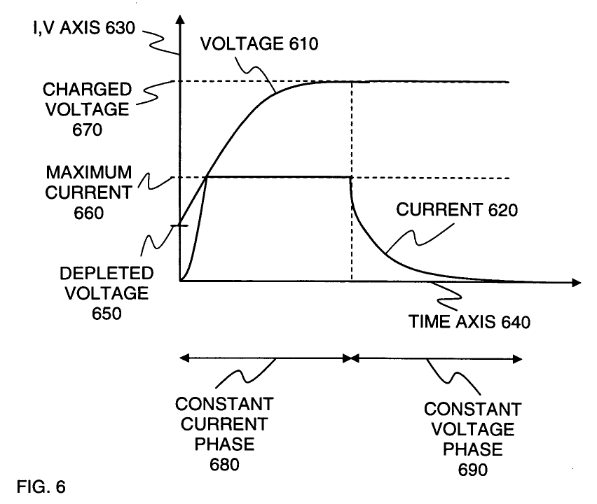

When charging a power source, pulse width modulation is often a two step, or two phase, process. For instance, FIG. 6 illustrates one embodiment of a voltage curve 610 and a current curve 620 for a slow rate battery, such as a lithium ion battery. The curves illustrate how the voltage and current change as the battery is recharged through a constant current phase 680 and a constant voltage phase 690. The vertical axis 630 corresponds to increasing current and voltage. The horizontal axis 640 corresponds to increasing time.

The battery is initially at depleted voltage 650. The charged voltage 670 for the battery may be substantially larger. Typical values could be about 3 V (volts) for the depleted voltage 650 and about 4.2 V for the charged voltage 670. In which case, if the charged voltage 670 was used as the reference signal and the voltage curve 610 was used as the feedback signal, the feedback signal would initially be much lower than the reference signal. In response, a pulse width modulator would quickly increase the average power of the modulated signal to close the gap between the reference and feedback. This could cause a large amount of current to source into the battery.

A lithium ion battery, however, can be damaged by a large amount of current. Therefore, rather than using the charged voltage 670 as the reference signal, a maximum current level 660 can be used as the reference instead. A typical reference current for a lithium ion battery may be about 1 A (ampere). So, as shown in FIG. 6, the current curve 620 can quickly ramp up to the maximum current 660, but will then level off at that value until the voltage curve 610 reaches the charged voltage 670. This period of time 680 is often called the constant current phase. It may last for an hour or more, depending on how depleted the battery is initially. At the completion of the constant current phase 680, even though the voltage curve 610 is at the charged voltage 670, the battery may still be a long way from being fully charged. For instance, the battery may only be at 50% to 60% of its maximum battery life at this point.

In which case, once the voltage curve 610 has reached the charged voltage level 670, the charger can safely switch over to using the charged voltage level 670 as the reference signal. The charger may continue to charge in this fashion for 2 hours or more as current trickles in to fully charge the battery. This is often called the constant voltage phase 690. A timer is often used to terminate the constant voltage phase 690. In one embodiment, termination of the constant voltage phase can be based on the fact that the source current has reached a pre-determined minimum level.

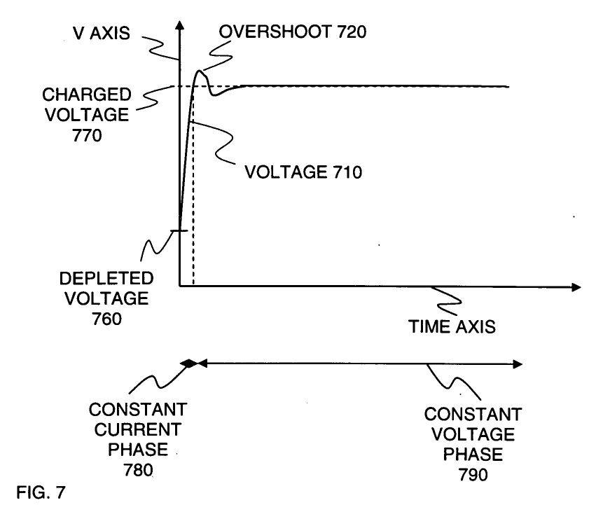

FIG. 7 illustrates one embodiment of a voltage curve 710 for a higher rate power source, such as a super capacitor. The illustrated embodiment goes through similar constant current and constant voltage phases 780 and 790 as the slower rate power source of FIG. 6. The difference here, however, is that the higher rate power source can withstand considerably more current. A typical reference current for a super capacitor in the constant current phase 780 may be, for instance, 10 A. In which case, the voltage curve 710 can shoot up from depleted voltage 760 to charged voltage 770 at a terrific rate. For example, a super capacitor may take just a few minutes to reach the charged voltage 770. And, once at the charged voltage, a super capacitor may already store 90% or more of its maximum battery life. The battery can then enter the constant voltage phase 790 for a period of time.

Of course, one potential hazard from such a fast recharge is a large overshoot 720 in voltage curve 710. If overshoot 720 is too large, the power source could be damaged or even explode. Any number of techniques can be used to curb the recharge rate as it approaches the charged voltage 770.

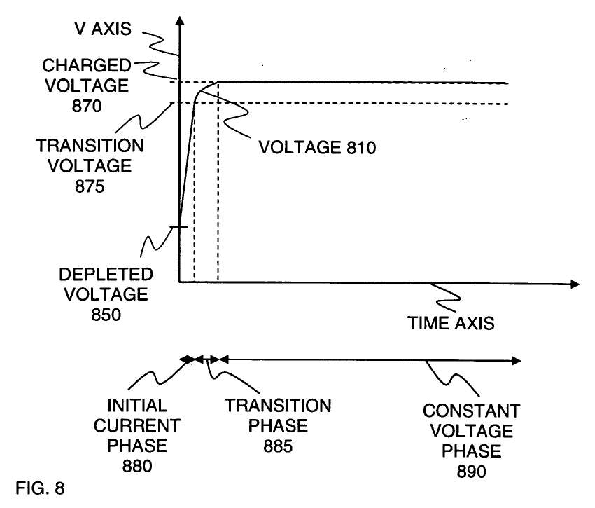

For instance, FIG. 8 illustrates one embodiment of a voltage curve 810 as it goes through two different current phases, an initial current phase 880 and a transition current phase 885, before entering the constant voltage phase 890. The initial current phase 880 could use a large reference current, such as the 10 A reference mention above. Then, when the voltage curve 810 reaches a transition voltage 875, the illustrated embodiment can switch over to a smaller reference current to reduce the rate at which the voltage curve 810 increases during the transition phase 885. The smaller reference current may still be considerably larger than the reference current used in the embodiment of FIG. 6. A typical value may be 5 A.

The transition phase 885 can reduce or eliminate any overshoot. The trade-off, of course, is a longer recharge time. The transition phase can be made quite short, however. For example, a typical increase in recharge time may be as little as 10 seconds.

Alternate embodiments can reduce or eliminate overshoot in any number of ways. For instance, decreasing the response time of the pulse width modulator could reduce overshoot. In another example, rather than switching to a transition phase at a particular voltage level, the initial current phase could last for a particular time duration. In yet another example, rather than using two discrete reference currents, the reference current could be tapered off in an analog fashion as the voltage curve approaches the charged voltage level.

Referring back to FIGS. 4 and 5, control unit 220 and charger 230 can work together to selectively apply appropriate recharging techniques, or modes, like those described in FIGS. 6 through 8. The recharging mode signal 470 from control unit 220 can be received at one or both of input ports 540 and 550 of modulator 510.

For example, the three recharging modes 420, 430, and 440 from FIG. 4 could correspond to the recharging modes illustrated in FIGS. 6, 8, and 7, respectively. That is, mode 420 could correspond to a lithium ion battery that should be recharged slowly using a low reference current during a constant current phase. Mode 430 could correspond to a battery that has a faster recharge rate, but is also susceptible to damage from a voltage overshoot. Mode 440 could correspond to a super capacitor that has a very fast recharge rate and is not susceptible to damage from any overshoot that is likely to occur.

In this example, the recharging mode signal 470 could use both ports 540 and 550. The mode port 540 could indicate whether to use a two phase charge mode (such as FIG. 6 or 7) or a three phase recharge mode (such as FIG. 8), and reference port 550 could be, or could indicate, one of two reference currents to use during the first phase, a low reference current or a high reference current. Then, to get the reference current for the transition phase in the three phase mode, the modulator could, for example, divide the initial reference current by some predetermined factor.

In an alternate embodiment, mode port 540 may not be needed at all. For example, control unit 220 could simply provide one of a variety of reference currents, or indications of references currents, at reference port 550. Then, based on the level of the reference current, modulator 510 could determine which of the potential recharging modes to use. For example, a low reference current could indicate the slow recharging mode. In which case, the low reference current could be used during the constant current phase before switching over to the constant voltage phase. A medium reference current could indicate the medium recharging mode. In which case, a multiple of the reference current could be used during the initial current phase, and the reference current itself could be used in the transition phase. And, a high reference current-could indicate the fast recharging mode. In which case, the high reference current could be used in the constant current phase before switching to the constant voltage phase.

In another example, the reference current at 550 may be a fixed value. In which case, control unit 220 could provide one of a variety of mode indicators at mode port 540. Each mode indicator could be, for instance, a multiplier for the fixed reference current at 550.

Other embodiments may use more or few recharging modes, and other embodiments may communicate indications for those recharging mode between the control unit and the charger in any number of ways. Furthermore, the recharging techniques that are described in FIGS. 6, 7, and 8 are merely examples. Embodiments of the present inventions can similarly be applied to other power source technologies and battery chemistries that may use completely different recharging techniques.

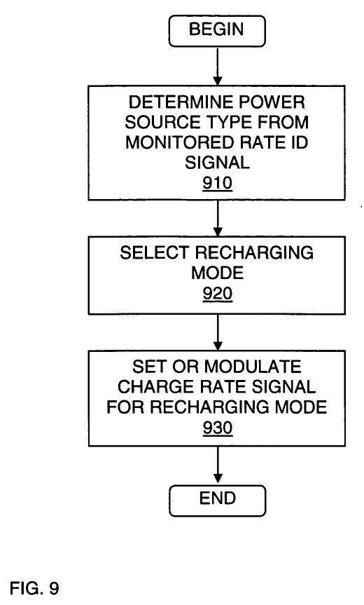

FIG. 9 demonstrates the process performed by one embodiment of the present invention. At 910, the process determines the power source type of a power pack by monitoring a rate identification signal. At 920, the process selects a recharging mode for the power pack based on the power source type. Then, at 930, the process sets or modulates a charge rate signal for the recharging mode.

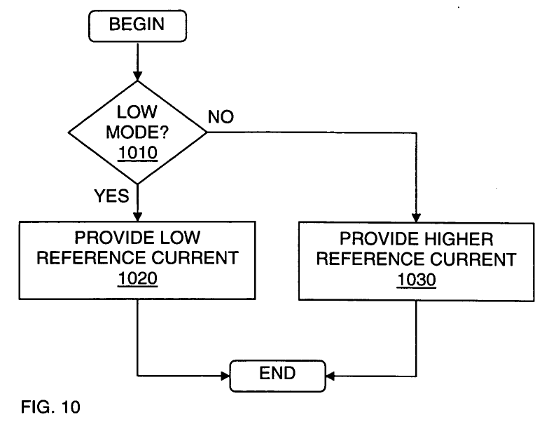

FIG. 10 demonstrates one embodiment of a process that can apply two different recharging modes. At 1010, the process determines which mode to apply. If the low rate mode has been selected, the process provides a low reference current to be used during a constant current phase at 1020. If, however, the high rate process has been selected, the process provides a high reference current to be used during a constant current phase at 1030.

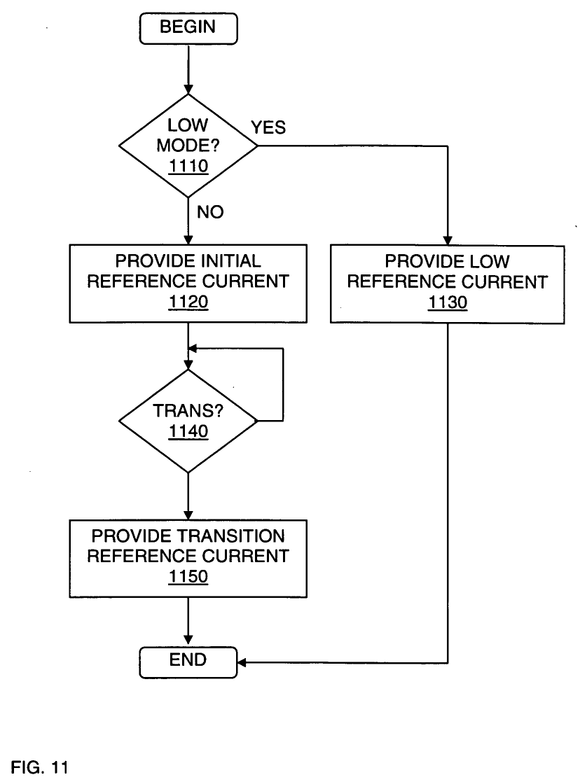

FIG. 11 demonstrates one embodiment of a process that can apply a low-rate, two-phase recharging mode or a high-rate, three-phase recharging mode. At 1110, the process determines which mode to apply. If the high rate mode has been selected, the process initially provides a high reference current. Then, at 1140, the process determines when to transition out of the initial phase. For example, the process could monitor a feedback voltage and transition when a particular transition voltage is reached. In another example, the process could wait for a particular duration of time. In any case, when the process determines it is ready to transition, it provides a transition reference current at 1150 to be used during a transition phase at 1150. If, however, back at 1110, the process determines that a low rate mode has been selected, the process provides a low reference current at 1130 to be used during a constant current phase.

The processes illustrated in FIGS. 9 through 11 are merely examples. Each process could be performed, for instance, by the control unit 220 in the power system 200 described above. In alternate embodiments, however, the process could be performed by any number of other circuits or devices, such as a charger, a processor executing software, etc. Furthermore, similar processes can be developed for other potential combinations of recharge modes and power packs.

FIGS. 1 through 11 include a number of implementation-specific details. Other embodiments of the present invention may not include all of the illustrated elements, may include additional elements, may combine or separate the functions of one or more of the illustrated elements, and the like.

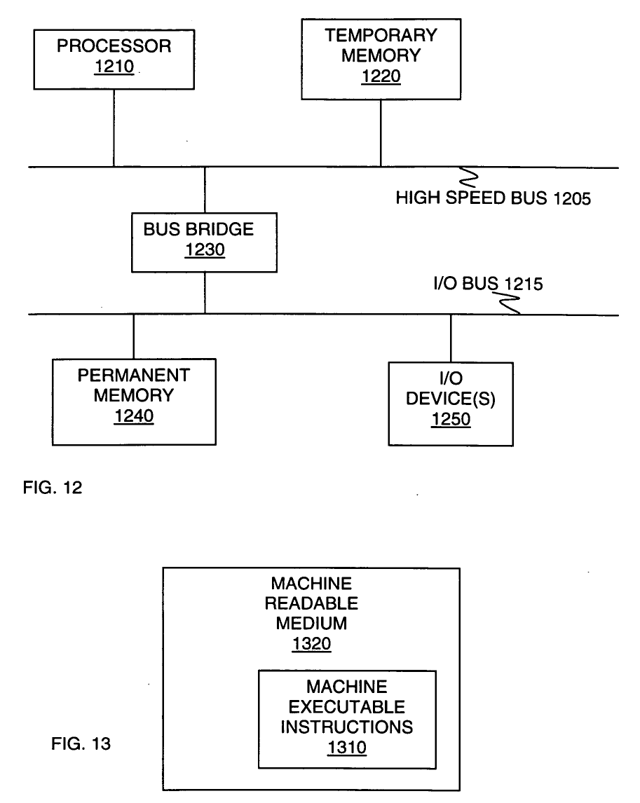

The description above primarily describes embodiments of the present invention implemented in hardware. Embodiments of the present invention, however, can be implemented in software or a combination of hardware and software. For example, FIG. 12 illustrates one embodiment of a generic hardware system intended to represent a broad category of computing systems or devices. In the illustrated embodiment, the hardware system includes processor 1210 coupled to high speed bus 1205, which is coupled to input/output (I/O) bus 1215 through bus bridge 1230. Temporary memory 1220 is coupled to bus 1205. Permanent memory 1240 is coupled to bus 1215. I/O device(s) 1250 is also coupled to bus 1215. I/O device(s) 1250 may include, for example, a number of ports and/or network interfaces.

Certain embodiments may include additional components, may not require all of the above components, or may combine one or more components. For instance, temporary memory 1220 may be on-chip with processor 1210. Alternately, permanent memory 1240 may be eliminated and temporary memory 1220 may be replaced with an electrically erasable programmable read only memory (EEPROM), wherein software routines are executed in place from the EEPROM. Some implementations may employ a single bus, to which all of the components are coupled, or one or more additional buses and bus bridges to which various additional components can be coupled. Similarly, a variety of alternate internal networks could be used including, for instance, an internal network based on a high speed system bus with a memory controller hub and an I/O controller hub. Additional components may include additional processors, a CD ROM drive, additional memories, and other peripheral components known in the art.

In one embodiment, various functions of the present invention, as described above, could be implemented as software routines executed by one or more hardware systems, such as the hardware system of FIG. 12. The software routines can be stored on a machine readable storage device, such as permanent memory 1240 or temporary memory 1220. Alternately, as shown in FIG. 13, the software routines can be machine executable instructions 1310 stored using any machine readable storage medium 1320, such as a hard drive, a diskette, CD-ROM, magnetic tape, digital video or versatile disk (DVD), laser disk, ROM, Flash memory, etc. The series of instructions need not be stored locally, and could be received from a remote storage device, such as a server on a network, a CD-ROM device, a floppy disk, etc., through, for instance, I/O device(s) 1250 of FIG. 12.

From whatever source, the instructions may be accessed and executed by processor 1210. In one implementation, these software routines are written in the C programming language. It is to be appreciated, however, that these routines may be implemented in any of a wide variety of programming languages.

Alternately, the embodiments of the present invention described above may be implemented in discrete hardware or firmware. For example, one or more application specific integrated circuits (ASICs) could be programmed with one or more of the above described functions. In another example, one or more functions of the present invention could be implemented in one or more ASICs on additional circuit boards and the circuit boards could be inserted into the computer(s) described above. In another example, field programmable gate arrays (FPGAs) or static programmable gate arrays (SPGA) could be used to implement one or more functions of the present invention. In yet another example, a combination of hardware and software could be used to implement one or more functions of the present invention.

Thus, high rate power source recharging is described. Whereas many alterations and modifications of the present invention will be comprehended by a person skilled in the art after having read the foregoing description, it is to be understood that the particular embodiments shown and described by way of illustration are in no way intended to be considered limiting. Therefore, references to details of particular embodiments are not intended to limit the scope of the claims.

What is claimed is:

1. A method comprising:
determining a power source type for a power pack installed in a device; and
selecting a recharging mode for the power pack based on the power source type.

2. The method of claim 1 wherein the power source type comprises one of a slow rate type, a medium rate type, or a high rate type.

3. The method of claim 1 wherein the power pack comprises at least one of a super capacitor or a chemical battery.

4. The method of claim 1 wherein determining the power source type comprises:
monitoring a rate identification signal from the power pack.

5. The method of claim 1 wherein selecting the recharging mode comprises:
sending a charge rate signal to a charger.

6. The method of claim 5 wherein sending the charge rate signal comprises:
setting the charge rate signal to a first value if the power source type is a high rate type; and
setting the charge rate signal to a second value if the power source type is a low rate type.

7. The method of claim 5 wherein sending the charge rate signal comprises:
modulating the charge rate signal to one of a plurality of average values to represent the power source type.

8. The method of claim 1 wherein selecting the recharging mode comprises:
providing one of a plurality of available reference currents to the charger.

9. The method of claim 8 wherein providing one of the plurality of available reference currents comprises:
providing a low reference current if the power source type is a low rate type; and
providing a higher reference current if the power source type is a higher rate type.

10. The method of claim 8 wherein providing one of the plurality of available reference currents comprises:
providing a low reference current if the power source type is a low rate type; and
providing a higher reference current during an initial phase, and providing a transition reference current during a transition phase, if the power source type is a higher rate type.

11. The method of claim 10 wherein the transition phase initiates at a particular feedback voltage level, and wherein the method further comprises:
detecting the particular feedback voltage level; and
switching from the higher reference current to the transition reference current in response to detecting the particular feedback voltage level.

12. The method of claim 10 wherein the transition phase initiates after a particular time duration, and wherein the method further comprises:
waiting for the particular time duration; and
switching from the higher reference current to the transition reference current after waiting.

13. An apparatus comprising:
identification circuitry to receive a rate identification signal from a power pack, said rate identification signal to indicate a power source type for the power pack;
a control unit to select a recharging mode for the power pack based on the power source type; and
a charger coupled to the control unit to recharge the power pack in the recharging mode selected by the control unit.

14. The apparatus of claim 13 wherein the identification circuitry comprises:
a resistive element coupled to a source voltage at a first end and the control unit at a second end; and
an input port to couple a rate indicator port on the power pack to the second end of the resistive element, said rate indicator port being a ground path on the second end of the resistive element to indicate a first power source type and said rate indicator port being an open circuit on the second end of the resistive element to indicate a second power source type.

15. The apparatus of claim 13 wherein the identification circuitry comprises:
a plurality of ports to couple a plurality of rate indicator ports on the power pack to the control unit, said plurality of indicator ports to indicate the power source type from among a plurality of potential power source types.

16. The apparatus of claim 13 wherein the control unit comprises:
a memory element to store a plurality of potential recharging mode indicators; and
a multiplexing element to select the recharging mode from among the plurality of potential recharging modes based on the power source type indicated by the rate identification signal.

17. The apparatus of claim 13 wherein the control unit comprises:
a modulator to modulate a signal line to one of a plurality of potential recharging mode indicators.

18. The apparatus of claim 13 wherein the charger comprises:
a pulse-width modulator to modulate a source current to recharge the power pack.

19. The apparatus of claim 18 wherein the pulse-width modulator comprises:
an input port to receive a recharging mode indicator from the control unit, said recharging mode indicator comprising a reference current for the pulse-width modulator to use in a constant current mode.

20. The apparatus of claim 18 wherein the pulse-width modulator comprises:
a first input port to receive a recharging mode indicator from the control unit; and
a second input port to receive from the control unit a reference current for the pulse-width modulator to use in a constant current mode.

21. The apparatus of claim 18 wherein the pulse-width modulator comprises:
an input port to receive a recharging mode indicator from the control unit, said recharging mode indicator comprising a gain factor for a reference current used by the pulse-width modulator in a constant current mode.

22. A power pack comprising:
a power core having a recharge rate; and
an indicator to indicate the recharge rate to a device when the power pack is installed in the device.

23. The power pack of claim 22 wherein the recharge rate comprises one of a low rate, a medium rate, and a fast rate.

24. The power pack of claim 22 wherein the indicator comprises:
an output port; and
a ground path coupled to the output port.

25. The power pack of claim 22 wherein the indicator comprises:
an output port; and
a source voltage coupled to the output port.

26. The power pack of claim 22 wherein the indicator comprises:
a plurality of output ports; and
a plurality of registers to store a value for each of the plurality of output ports.

27. A machine readable medium having stored thereon machine executable instructions, the execution of which implement a method comprising:
determining a power source type for a power pack installed in a device; and
selecting a recharging mode for the power pack based on the power source type.

28. The machine readable medium of claim 27 wherein selecting the recharging mode comprises:
sending a charge rate signal to a charger.

29. The machine readable medium of claim 27 wherein selecting the recharging mode comprises:
providing one of a plurality of available reference currents to the charger.

30. A system comprising:
a notebook computer; and
a power delivery system, said power delivery system comprising
identification circuitry to receive a rate identification signal from a power pack, said rate identification signal to indicate a power source type for the power pack;
a control unit to select a recharging mode for the power pack based on the power source type; and
a charger coupled to the control unit to recharge the power pack in the recharging mode selected by the control unit.

31. The system of claim 30 wherein the identification circuitry comprises:
a resistive element coupled to a source voltage at a first end and the control unit at a second end; and
an input port to couple a rate indicator port on the power pack to the second end of the resistive element, said rate indicator port being a ground path on the second end of the resistive element to indicate a first power source type and said rate indicator port being an open circuit on the second end of the resistive element to indicate a second power source type.

32. The system of claim 30 wherein the control unit comprises:
a memory element to store a plurality of potential recharging mode indicators; and
a multiplexing element to select the recharging mode from among the plurality of potential recharging modes based on the power source type indicated by the rate identification signal.

33. The system of claim 30 wherein the charger comprises:
a pulse-width modulator to modulate a source current to recharge the power pack.
